(19) United States
(12) Patent Application Publication
(10) Pub. No.: US 2026/0292324 A1
(43) Pub. Date: Sep. 24, 2026

(54) GENERATING INDICATIONS OF A FACE LOOKING AWAY FROM A CAMERA

(71) Applicant: Motorola Mobility LLC, Chicago, IL (US)

(72) Inventors: Ranjeet Gupta, Aurora, IL (US); Rahul Bharat Desai, Hoffman Estates, IL (US)

(73) Assignee: Motorola Mobility LLC, Chicago, IL (US)

(21) Appl. No.: 19/083,089

(22) Filed: Mar. 18, 2025

(51) Int. Cl. H04N 23/611; H04N 23/56; H04N 23/63

(52) U.S. Cl. CPC H04N 23/611; H04N 23/56; H04N 23/632; H04N 23/634

(57) ABSTRACT

In aspects of generating indications of a face looking away from a camera, a mobile device implements a gaze manager that identifies faces within a field of view of a camera associated with the mobile device. The gaze manager determines whether the faces are looking toward the camera. The gaze manager then outputs a preview image of the faces, including at least one indication of a face that is looking away from the camera, for display on a display device associated with the mobile device that is viewable from a point of view of the faces. Based on detecting that the face that is looking away from the camera has repositioned to looking toward the camera, the gaze manager then causes the mobile device to capture a digital image using the camera.

### BACKGROUND

Mobile devices typically include cameras for capturing digital images. For example, a mobile device may be used to capture a digital image of a group of people. However, capturing quality images of groups of people is challenging. For instance, different mobile devices have cameras incorporated in different areas of a mobile device, and some people do not know where to look to face the camera. Additionally, some people in a group may not know a digital image is about to be captured and may not be facing the mobile device. Without all participants facing the camera, an undesirable digital image is captured, with some people looking off-frame or not clearly visible.

### BRIEF DESCRIPTION OF THE DRAWINGS

Implementations of techniques for generating indications of a face looking away from a camera are described with reference to the following Figures. The same numbers may be used throughout to reference like features and components shown in the Figures.

FIG. 1 illustrates an example system for generating indications of a face looking away from a camera in accordance with one or more implementations as described herein.

FIG. 2 illustrates an example of a mobile device that may be implemented for generating indications of a face looking away from a camera in accordance with one or more implementations as described herein.

FIG. 3 illustrates an example of an environment of the mobile device for generating indications of a face looking away from a camera.

FIG. 4 further illustrates an example of generating indications of a face looking away from a camera, including determining whether faces are looking toward a camera and outputting a preview image including an indication of which faces are facing away from the camera.

FIG. 5 further illustrates an example of generating indications of a face looking away from a camera, including providing an indicator of a location of the camera.

FIG. 6 further illustrates an example of generating indications of a face looking away from a camera, including outputting instructions to face the camera.

FIG. 7 further illustrates an example of generating indications of a face looking away from a camera, including updating the indication of which faces are facing away from the camera in response to detecting that the face that is looking away from the camera has repositioned to looking toward the camera.

FIG. 8 further illustrates an example of generating indications of a face looking away from a camera, including automatically capturing a digital image in response to determining that the faces are looking toward the camera.

FIG. 9 is a flowchart illustrating an example of generating indications of a face looking away from a camera in accordance with one or more implementations as described herein.

FIG. 10 illustrates an example method for generating indications of a face looking away from a camera in accordance with one or more implementations of the techniques described herein.

FIG. 11 illustrates an example method for generating indications of a face looking away from a camera in accordance with one or more implementations of the techniques described herein.

FIG. 12 illustrates various components of an example device that may be used to implement the techniques for generating indications of a face looking away from a camera in accordance with one or more implementations as described herein.

### DETAILED DESCRIPTION

Implementations of the techniques for generating indications of a face looking away from a camera may be implemented as described herein. A mobile device, such as any type of mobile phone or computing device, may be configured to perform the techniques for generating indications of a face looking away from a camera. In one or more implementations, a gaze manager, housed in the mobile device, a central computing device, or a network-based cloud accessible to the mobile device, can be used to implement aspects of the techniques described herein.

Mobile devices may include cameras for capturing digital images. For example, a mobile device may include a front-facing camera configured to capture a front-facing digital image (e.g., a “selfie” of the user of the mobile device) and a rear-facing camera configured to capture a rear-facing digital image (e.g., of scenery in front of the user). Because the cameras may capture digital video in addition to digital images, the cameras are useful for a variety of activities, including photography, video calls, or other forms of communication.

However, while the cameras are useful for a variety of activities, some disadvantages are evident related to utilizing the cameras to capture digital images of groups of people. For example, assume a user is attempting to capture a digital image of a group of people facing the user using a rear-facing camera of a mobile device. Unfortunately, because different mobile devices have cameras located at different positions, some of the people in the group may not know where to look. For instance, the camera is located in an upper-left corner of the mobile device, but one of the people is looking to the upper-right corner of the mobile device. Additionally, one of the other people is unaware an image is being taken and is not looking at the mobile device. Because neither of the people are looking toward the camera, an undesirable digital image is captured, as the faces of the people depicted in the digital image are looking off-frame.

Techniques and systems are described for generating indications of a face looking away from a camera that overcome these limitations. The gaze manager receives a preview image captured by the camera of the mobile device. The preview image, for instance, is captured prior to capture of a digital image. For example, the mobile device is positioned to capture a digital image of a group of people using the camera, which is a rear-facing camera. The mobile device in this example is a foldable device including a front-facing display viewable by the user of the mobile device and a rear-facing display viewable by the group of people. In response to receiving a user input to capture a digital image of the group of people (e.g., actuation of a camera button on a user interface), the gaze manager causes the camera to capture the preview image for purposes of determining and managing gazes for faces of the people in the group. The preview image is then output for display on the rear-facing display. Although this example contemplates use of a rear-facing camera in conjunction with a rear-facing display, other examples may involve a front-facing camera and a front-facing display for generating indications of a face looking away from a camera from a user perspective, for instance using the mobile device in “selfie” mode.

After the preview image is captured, the gaze manager performs feature detection to detect faces depicted in the preview image. To do this, the gaze manager may leverage a machine learning model trained to identify or detect faces in digital images. Using the machine learning model, the gaze manager isolates the faces from the rest of the preview image.

After the gaze manager detects faces in the preview image, the gaze manager determines whether the faces are looking toward the camera. To do this, the gaze manager may leverage a machine learning model trained to track gazes of identified faces. For instance, the gaze manager may identify eyes of identified faces, determine which direction the eyes are looking, and based on a known location of the camera relative to the preview image (e.g., center of the preview image), the gaze manager may determine whether a given identified face is looking toward the camera. This may be repeated for each face identified in the preview image.

After the gaze manager determines whether the faces are looking toward the camera, the gaze manager produces an output identifying which of the faces are looking toward the camera. In this example implementation, the preview image is displayed on the display device, which is viewable by the group of people. In an example implementation, the gaze manager may incorporate a green outline box around a face identified in the preview image to identify that the face is looking toward the camera, and the gaze manager may incorporate a red outline box around a different face identified in the preview image to identify that the additional face is looking away from the camera. Although this example contemplates usage of red and green to indicate which faces are looking toward the camera, other examples may use any combination of colors, symbols, or other indications to indicate which faces are looking toward the camera.

The purpose for incorporating the red outline box around the face is to alert a person corresponding to the additional face that they are not looking toward the camera. For example, after seeing the red outline box, the person shifts their gaze so that they are looking toward the camera. In some example implementations, the gaze manager may be configured to cause the camera to automatically capture a digital image after determining that all faces depicted in the preview image are looking toward the camera.

The described techniques for generating indications of a face looking away from a camera overcome the limitations of conventional systems. For example, identifying faces within a field of view of a camera, determining whether the faces are looking toward the camera, and outputting a preview image of the faces including an indication of a face that is looking away from the camera results in an effective prompt for people to adjust their gaze to be looking toward the camera. This assists the subjects of the digital image by communicating where to look for the picture. Generating indications of a face looking away from a camera also alleviates user frustration for the photographer, resulting in aesthetically-pleasing digital images that avoid faces looking out of the frame of the digital image.

Additionally, generating indications of a face looking away from a camera may result in a variety of technical benefits related to the mobile device. For instance, users of the conventional systems typically capture several unnecessary digital images when photographing groups of people. For instance, one person may be looking away from the camera in a first image, a different person may be looking away from the camera in a second image, and it may take several attempts to capture a digital image with all people looking toward the camera. These images are typically stored in memory associated with the mobile device, resulting in wasted storage space dedicated to unwanted images. In contrast, generating indications of a face looking away from a camera involves capturing a preview image, which is used to determine whether the people are looking toward the camera, before a digital image is captured. Because the preview image is not stored in the memory associated with the mobile device in this example, additional storage space is saved compared to the conventional systems.

While features and concepts of the described techniques for generating indications of a face looking away from a camera is implemented in any number of different devices, systems, environments, and/or configurations, implementations of the techniques for generating indications of a face looking away from a camera are described in the context of the following example devices, systems, and methods.

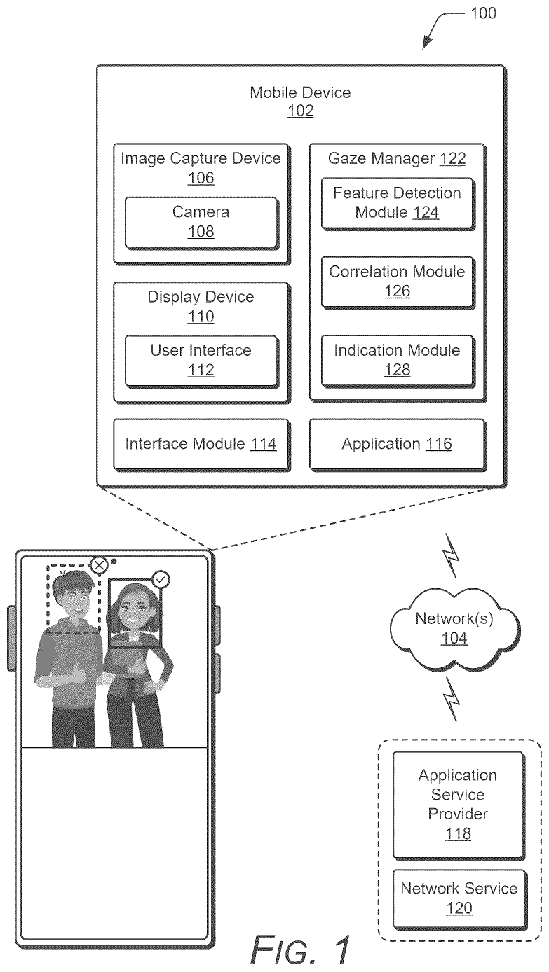

FIG. 1 illustrates an example system 100 for generating indications of a face looking away from a camera. The system 100 includes a mobile device 102 and a communication network 104. Examples of the mobile device 102 include at least one of any type of a wireless device, mobile device, mobile phone, flip phone, client device, companion device, tablet, computing device, communication device, entertainment device, gaming device, media playback device, any other type of computing and/or electronic device.

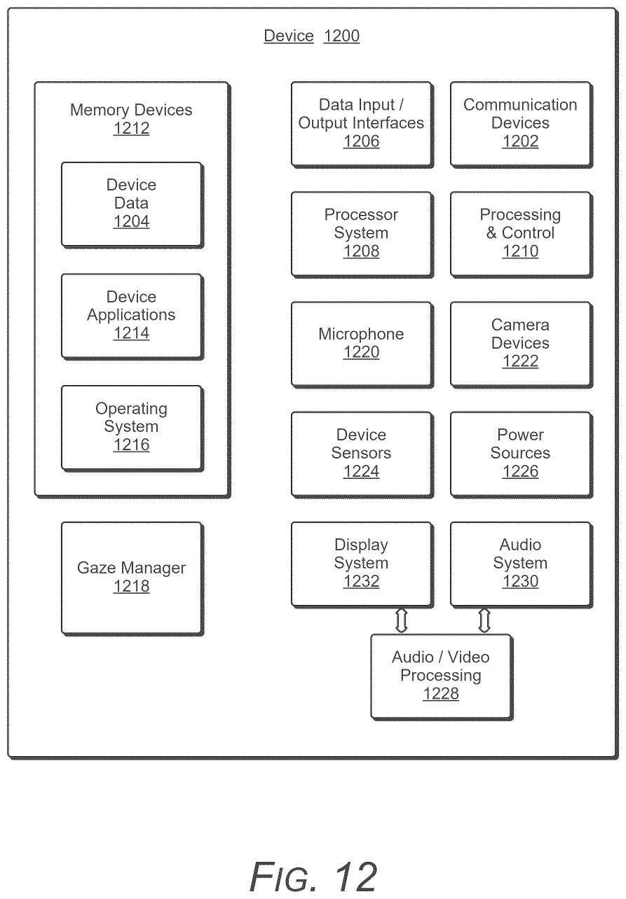

The mobile device 102 can be implemented with various components, such as a processor system and memory, as well as any number and combination of different components as further described with reference to the example device shown in FIG. 12. In implementations, the mobile device 102 is equipped with an image capture device 106, such as a camera 108 to capture digital images. In some implementations, the mobile device 102 may include multiple cameras for capturing video content from various perspectives of the mobile device 102. For instance, the mobile device 102 includes a first camera that captures an image of a user, e.g., a front facing camera, and a second camera that captures a visual scene, e.g., a rear facing camera.

The mobile device 102 can be implemented with a display device 110 configured to display a user interface 112. The display device 110 represents functionality (e.g., hardware and logic) for enabling visual output via the mobile device 102. For instance, via the user interface 112. In some example implementations, the mobile device 102 includes multiple display devices for displaying different visual content simultaneously for viewing from various perspectives around the mobile device 102.

In some implementations, the devices, applications, modules, servers, and/or services described herein communicate via the communication network 104, such as for data communication with the mobile device 102. An interface module 114 includes a wired and/or a wireless network. The interface module 114 is implemented using any type of network topology and/or communication protocol and is represented or otherwise implemented as a combination of two or more networks, to include IP based networks, cellular networks, and/or the Internet. The communication network 104 includes mobile operator networks that are managed by a mobile network operator and/or other network operators, such as a communication service provider, mobile phone provider, and/or Internet service provider.

The mobile device 102 includes various functionalities that enable the devices to implement different aspects of generating indications of a face looking away from a camera, as described herein. In one or more examples, an interface module 114 represents functionality (e.g., logic and/or hardware) enabling the mobile device 102 to interconnect and interface with other devices and/or networks, such as the communication network 104. For example, the interface module 114 enables wireless and/or wired connectivity of the mobile device 102.

The mobile device 102 can include and implement an application 116, such as any type of camera application, image capture application, video capture application, messaging application, email application, video communication application, cellular communication application, music/audio application, gaming application, media application, social platform applications, and/or any other of the many possible types of various device applications. Many of the device applications have an associated application user interface that is generated and displayed for user interaction and viewing, such as on a display screen of the mobile device 102. Generally, an application user interface, or any other type of video, image, graphic, and the like is digital image content that is displayable on the display screen of the mobile device 102. The application 116 may be accessible to the mobile device 102 from an application service provider 118 via the communication network 104. Functionalities of the application 116 may be implemented using a network service 120, such as a cloud-based service, in communication with the mobile device 102 via the communication network 104.

In the example system 100 for generating indications of a face looking away from a camera, the mobile device 102 implements a gaze manager 122. In some examples, the gaze manager 122 may be implemented in an external device in communication with the mobile device 102 via the communication network 104. As shown in this example, the gaze manager 122 represents functionality (e.g., logic, software, and/or hardware) enabling aspects of the described techniques for generating indications of a face looking away from a camera 108. The gaze manager 122 can be implemented as computer instructions stored on computer-readable storage media and can be executed by a processor system of the mobile device 102. Alternatively, or in addition, the gaze manager 122 can be implemented at least partially in hardware of the device.

In one or more implementations, the gaze manager 122 includes independent processing, memory, and/or logic components functioning as a computing and/or electronic device integrated with the mobile device 102. Alternatively, or in addition, the gaze manager 122 can be implemented in software, in hardware, or as a combination of software and hardware components. In this example, the gaze manager 122 is implemented as a software application or module, such as executable software instructions (e.g., computer-executable instructions) that are executable with a processor system of the mobile device 102 to implement the techniques and features described herein. As a software application or module, the gaze manager 122 can be stored on computer-readable storage memory (e.g., memory of a device), or in any other suitable memory device or electronic data storage implemented with the controller. Alternatively or in addition, the gaze manager 122 is implemented in firmware and/or at least partially in computer hardware. For example, at least part of the gaze manager 122 is executable by a computer processor, and/or at least part of the content manager is implemented in logic circuitry.

In this example system 100, the gaze manager 122 is configured to identify faces depicted in a preview image and determine whether the faces are looking toward the camera 108. The gaze manager 122 generates and outputs indications of a face looking away from the camera 108 to prompt people to reposition their gaze to be looking at the camera 108 before a digital image is captured.

To generate indications of a face looking away from a camera, the gaze manager 122 includes a feature detection module 124. For example, the feature detection module 124 receives a preview image captured by the camera 108 of the mobile device 102. The preview image, for instance, is captured before a digital image is intended to be captured, and the preview image provides a sample of the scene within the frame of the camera. The feature detection module 124 then performs feature detection to detect faces depicted in the preview image. To do this, the feature detection module 124 may leverage a machine learning model trained to identify or detect faces in digital images.

The gaze manager 122 also includes a correlation module 126. After the feature detection module 124 detects faces in the preview image, the correlation module 126 determines whether the faces are looking toward the camera 108. To do this, the correlation module 126 may leverage a machine learning model trained to track gaze of identified faces. For instance, the correlation module 126 identifies eyes of identified faces, determines which direction the eyes are looking, and based on a known location of the camera 108 relative to the preview image (e.g., center of the preview image), the correlation module 126 determines whether the given identified face is looking toward the camera 108. This may be repeated for each face identified in the preview image. Although discussed separately, the functionality of the feature detection module 124 and the correlation module 126 may be performed simultaneously in some examples to both detect faces and determine which faces are looking toward the camera 108. In some implementations, the feature detection module 124 may also identify people who correlate to the faces depicted in the preview image.

The gaze manager 122 also includes an indication module 128. After the correlation module 126 determines whether the faces are looking toward the camera 108, the indication module 128 produces an output identifying which of the faces are looking toward the camera 108. In this example implementation, the preview image is displayed on the display device 110, which is viewable by the subjects of the preview image (i.e., the display device 110 is located on the same side of the mobile device 102 as the camera 108 used to capture the preview image). In an example implementation, the indication module 128 may incorporate a green outline box around a face identified in the preview image to identify that the face is looking toward the camera 108, and the indication module 128 may incorporate a red outline box around a different face identified in the preview image to identify that the additional face is looking away from the camera 108. In another example implementation, the indication module 128 may incorporate a check mark or other identifier over or around a face identified in the preview image to identify that the face is looking toward the camera 108, and the indication module 128 may incorporate an ‘X’ or other identifier over or around a different face identified in the preview image to identify that the additional face is looking away from the camera 108.

The purpose for incorporating the red outline box, the ‘X,” or the other identifier is to alert a person corresponding to the additional face that they are not looking toward the camera 108. For example, after seeing the red outline box, the ‘X,” or the other identifier, the person shifts their gaze so that they are looking toward the camera. In some example implementations, the gaze manager 122 causes capture of an updated preview image and provides feedback indicating that the person is looking toward the camera, such as incorporating a green outline box around the face now that the face is looking toward the camera 108. Additionally, in some example implementations, the gaze manager 122 may be configured to cause the camera 108 to automatically capture a digital image after determining that all faces depicted in the preview image are looking toward the camera.

Although this example involves producing an indication of a face that is looking away from the camera 108 for incorporation onto a preview image 402, other example implementations may involve producing an indication of a face that is looking away from the camera 108 for incorporation onto a live video. For instance, the indication module 128 produces an output identifying which of the faces are looking toward the camera 108 for incorporation onto a live video, which the indication module 128 adjusts in real-time based on movement of the faces in the live video.

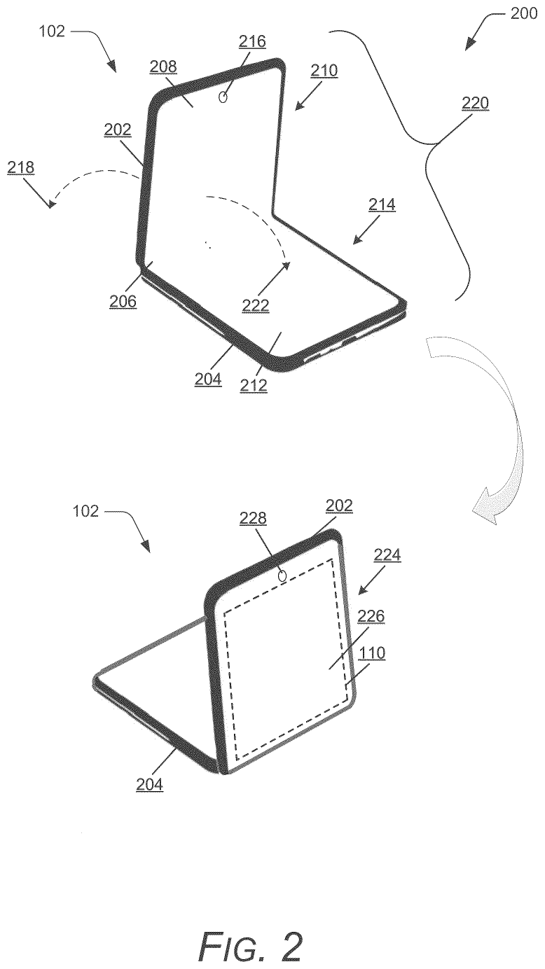

FIG. 2 illustrates example 200 of a mobile device 102 for displaying content based on detected force on a multi-display device, as described herein. The view depicted in FIG. 2, for instance, represents an interior, front-facing view of the mobile device 102. The mobile device 102 includes a first housing 202 attached to a second housing 204 via a hinge region 206. The first housing 202 and/or the second housing 204, for instance, are pivotable about the hinge region 206 to assume a variety of different angular orientations relative to one another. The first housing 202 includes an upper display device 208 positioned on an upper front-facing surface 210 of the first housing 202, and the second housing 204 includes a lower display device 212 positioned on a lower front-facing surface 214 of the second housing 204. The mobile device 102 further includes a front-facing camera 216 positioned on the upper display device 208 of the first housing 202. The front-facing camera 216 is positionable in various ways, such as within the perimeter of the upper display device 208 and/or underneath the upper display device 208. Alternatively or additionally, the front-facing camera 216 is positionable adjacent the upper display device 208.

In the depicted orientation, the mobile device 102 is in a partially open position with the first housing 202 pivoted away from the second housing 204. The first housing 202 is further pivotable about the hinge region 206 away from the second housing 204 to a fully open position 218. In the fully open position 218, for instance, the first housing 202 is substantially coplanar with the second housing 204. For example, in the fully open position 218 the upper display device 208 and the lower display device 212 are coplanar and form a single integrated display surface, which is herein referred to as the additional display device 220. The first housing 202 is also pivotable about the hinge region 206 to a closed position 222 where the upper display device 208 is positioned against the lower display device 212. In at least one implementation a hinge sensor is able to detect an orientation of the mobile device 102, e.g., based on an orientation of the first housing 202 relative to the second housing 204. The hinge sensor, for instance, can detect an angle of the first housing 202 relative to the second housing 204, and/or an amount of pivoting motion and/or rotation of the hinge region 206. Detecting the orientation of the mobile device 102 can be utilized for various purposes, such as for determining how to present the digital content and/or what digital content to be present on the different display devices of the mobile device 102. Although the mobile device 102 is depicted and described as a foldable mobile device, the mobile device 102 may not be foldable, yet may still be configured with the display device 110 on one side of the mobile device 102 and the additional display device 220 on an opposite facing side of the mobile device 102.

FIG. 2 also illustrates a rear-facing view of the mobile device 102, such as in the partially open position. In this view, a rear surface 224 of the first housing 202 is illustrated, and the rear surface 224 includes a rear-facing display device 226, which is also herein referred to as the display device 110. Further, the rear surface 224 includes a rear-facing camera 228 positioned on the rear surface 224 of the first housing 202. The rear-facing camera 228 is positionable in various ways, such as within the perimeter of the rear-facing display device 226 and/or underneath the rear-facing display device 226. Alternatively or additionally, the rear-facing camera 228 is positionable adjacent the rear-facing display device 226.

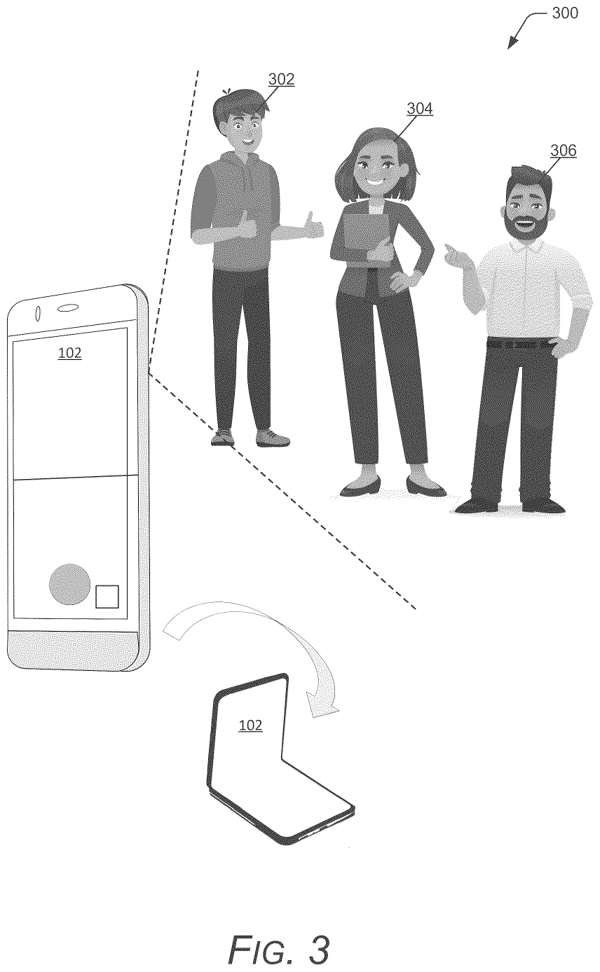

FIG. 3 illustrates an example 300 of an environment of the mobile device for generating indications of a face looking away from a camera. In the example 300, a mobile device 102 implementing a gaze manager 122 is positioned to capture a digital image of a group of people.

For example, a camera 108 of the mobile device 102 is positioned to capture images depicting a first face 302, a second face 304, and a third face 306, corresponding to individual people in the group of people. In this example, the mobile device 102 is the foldable device described with respect to FIG. 2. For instance, the camera 108 corresponds to the rear-facing camera 228 in this example. However, in other examples, the camera 108 may correspond to the front-facing camera 216.

The mobile device 102 in this example is positioned relative to the group of people, including the first face 302, the second face 304, and the third face 306 within a field of view of the camera 108. As described with respect to FIG. 2, the mobile device 102 also includes a display device 110 (also referred to as the display device is viewable from a point of view of the faces) positioned on the rear surface 224 and viewable by the group of people. For instance, the group of people can view images displayed on the display device 110, such as a preview image or a digital image captured by the camera 108. In some example implementations, the preview image may be reversed or mirrored for display on the display device 110 so that the group of people can view themselves from a mirror-like view in real-time.

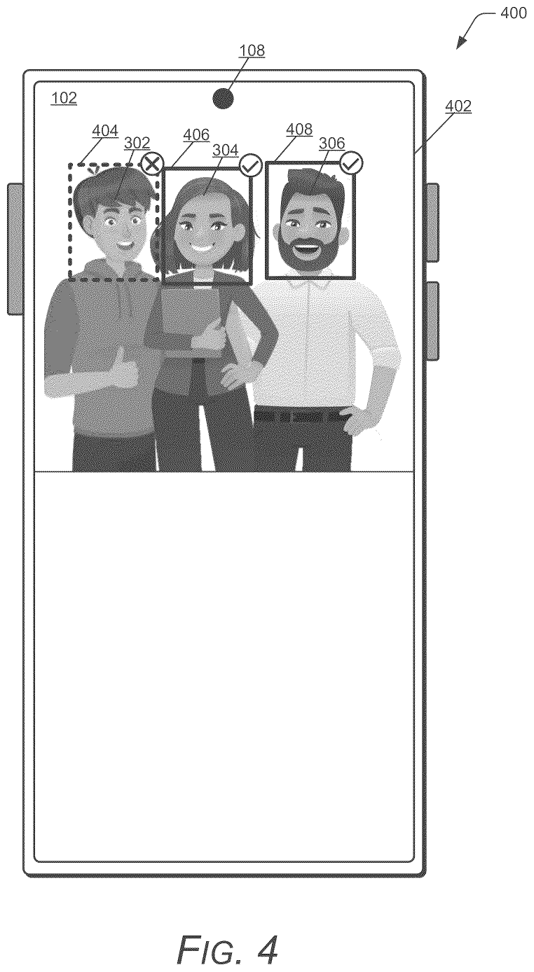

FIG. 4 illustrates an example 400 of generating indications of a face looking away from a camera, including determining whether faces are looking toward a camera and outputting a preview image including an indication of which faces are facing away from the camera, as described herein. The example 400 is a continuation of the example 300 described with respect to FIG. 3.

In the example 400, the gaze manager 122 may include a feature detection module 124 to detect faces in a preview image 402. In some examples, the gaze manager 122 may receive an indication that a user of the mobile device 102 intends to capture a digital image (e.g., camera button actuated on a touch display of the mobile device 102) and causes capture of the preview image 402. The preview image 402, for instance, is captured before a digital image is intended to be captured, and the preview image 402 provides a sample of the scene within the frame of the camera. The feature detection module 124 then performs feature detection to detect faces depicted in the preview image 402. To do this, the feature detection module 124 may leverage a machine learning model trained to identify or detect faces in digital images. The machine learning model may identify faces in the preview image 402 by first detecting facial regions. In some examples, this may also involve recognizing unique patterns to distinguish individuals. Face detection models may locate faces by analyzing pixel features and landmarks including eyes, noses, and/or mouths.

The gaze manager 122 may also include a correlation module 126. After the feature detection module 124 detects faces in the preview image 402, the correlation module 126 determines whether the faces are looking toward the camera 108. To do this, the correlation module 126 may leverage a machine learning model trained to track gaze of identified faces. The machine learning model may use deep learning-based recognition models like to convert facial images into numerical embeddings that capture distinguishing features for identifying eyes and tracking gazes of the faces depicted in the preview image 402. For instance, the correlation module 126 identifies eyes of identified faces, determines which direction the eyes are looking, and based on a known location of the camera 108 relative to the preview image 402 (e.g., center of the preview image 402), the correlation module 126 determines whether the given identified face is looking toward the camera 108. This may be repeated for each face identified in the preview image 402. Although discussed separately, the functionality of the feature detection module 124 and the correlation module 126 may be performed simultaneously in some examples to both detect faces and determine which faces are looking toward the camera 108. In some implementations, the feature detection module 124 may also identify people who correlate to the faces depicted in the preview image 402.

The gaze manager 122 also includes an indication module 128. After the correlation module 126 determines whether the faces are looking toward the camera 108, the indication module 128 produces an output involving the preview image 402 for display on the display device 110 identifying which of the faces are looking toward the camera 108. In this example implementation, the preview image 402 is displayed on the display device 110, which is viewable from a point of view of the faces (i.e., the display device 110 is located on the same side of the mobile device 102 as the camera 108 used to capture the preview image 402).

As shown in this example, the gaze manager 122 outputs a first indication 404 over the first face 302 indicating that the first face 302 is looking away from the camera 108, a second indication 406 over the second face 304 indicating that the second face 304 is looking toward the camera 108, and a third indication 408 over the third face 306 indicating that the third face 306 is looking toward the camera 108. The first indication 404 in this example is a red dotted line surrounding the first face 302 and marked with an ‘X.’ Meanwhile, second indication 406 and the third indication 408 are green solid lines over the second face 304 and the third face 306 and marked with a checkmark. Although this example contemplates use of the red dotted line to indicate a face that is looking away from the camera 108 and green solid line to indicate a face that is looking toward the camera 108, other examples may use any other color or type of markings to indicate a face that is looking away from the camera 108 or a face that is looking toward the camera 108.

Although this example contemplates use of generating indications of a face looking away from a camera for faces of people, other example implementations may involve animal faces. For example, the feature detection module 124 may perform feature detection to detect animal faces (e.g., faces of dogs, cats, horses, or other animals) depicted in the preview image 402. To do this, the feature detection module 124 may leverage a machine learning model trained to identify or detect animal faces. Additionally, the correlation module 126 may determine whether the animal faces are looking toward the camera 108 using a machine learning model trained to track gaze of the identified animal faces. Afterward, the indication module 128 may produce an output involving the preview image 402 for display on the display device 110 identifying which of the animal faces are looking toward the camera 108. For instance, the output may communicate to a pet owner than one of their pets is not looking toward the camera 108, and the pet owner may initiate further action to attract the pet's gaze toward the camera 108.

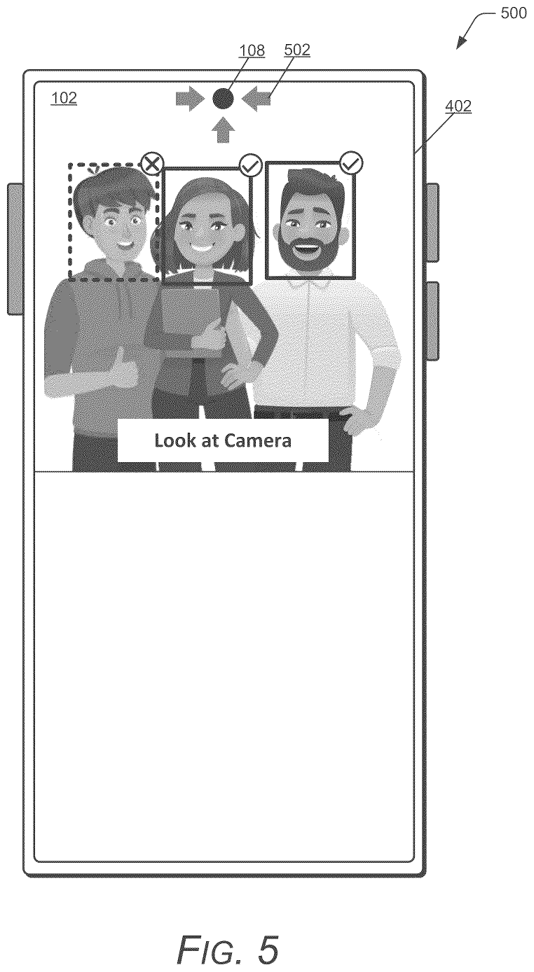

FIG. 5 illustrates an example 500 of generating indications of a face looking away from a camera, including providing an indicator of a location of the camera, as described herein. The example 500 is an alternative of the example 400 described with respect to FIG. 4.

After the feature detection module 124 detects faces in the preview image 402 and the correlation module 126 determines whether the faces are looking toward the camera 108, the indication module 128 may produce an output involving instructions for faces looking away from the camera 108 on the display device 110, which is viewable from a point of view of the faces.

In the example 500, the indication module 128 determines that at least one of the faces is looking away from the camera 108 because the correlation module 126 determines that the first face 302 is looking away from the camera. In response, the indication module 128 outputs visual instructions for display in the interface module 114 with text reading “Look at Camera” to remind the person corresponding to the first face 302 to look at the camera. In other example implementations, the visual instructions may be specifically targeted toward a specific person, for instance, by leveraging facial recognition to determine a name corresponding to a face and using the name to specifically attract the attention of the person.

The indication module 128 may also output an indication that shows or explains specifically where to look toward the camera 108. As shown in this example, the gaze manager 122 outputs arrows 502 for display relative to the preview image 402 in the user interface 112 of the display device 110 indicating where to look. For example, the arrows 502 point toward the camera 108. Other example implementations may involve display of a cartoon or other graphic configured to attract attention toward the camera 108.

Additionally, in some example implementations, the gaze manager 122 may cause a light associated with the camera 108 of the mobile device 102 to flash, indicating where to look toward the camera 108. For example, the gaze manager 122 causes a flash associated with the camera 108 to actuate in order to draw focal attention toward the camera 108.

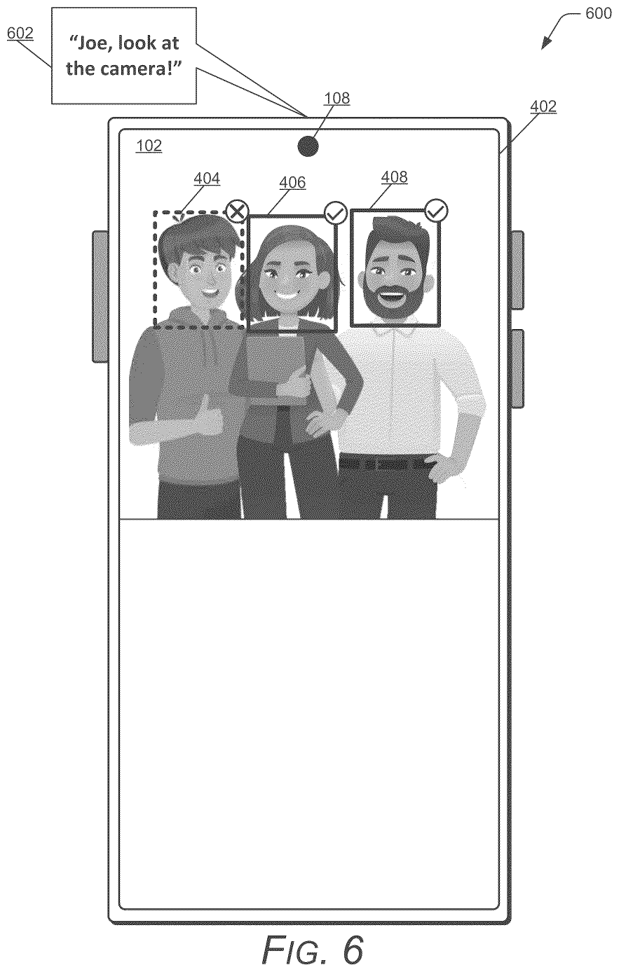

FIG. 6 illustrates an example 600 of generating indications of a face looking away from a camera, including outputting instructions to face the camera, as described herein. The example 600 is an alternative of the example 400 described with respect to FIG. 4.

After the feature detection module 124 detects faces in the preview image 402 and the correlation module 126 determines whether the faces are looking toward the camera 108, the indication module 128 may produce an output involving instructions for faces looking away from the camera 108. For example, the output may involve an audible message output from speakers associated with the mobile device 102.

In the example 600, the indication module 128 determines that at least one of the faces is looking away from the camera 108 because the correlation module 126 determines that the first face 302 is looking away from the camera. In response, the indication module 128 outputs audible instructions 602 saying “Joe, look at the camera” from at least one speaker associated with the mobile device 102 to remind the person corresponding to the first face 302 to look at the camera. In this example, the audible instructions 602 are specifically targeted toward a specific person, for instance, by leveraging facial recognition to determine a name corresponding to a face and using the name to specifically attract the attention of the person. For example, the indication module 128 determines the name corresponding to the first face 302 is “Joe” using any one of a variety of facial recognition techniques and uses the name to generate the audible instructions 602 saying “Joe, look at the camera” to attract attention from that specific person.

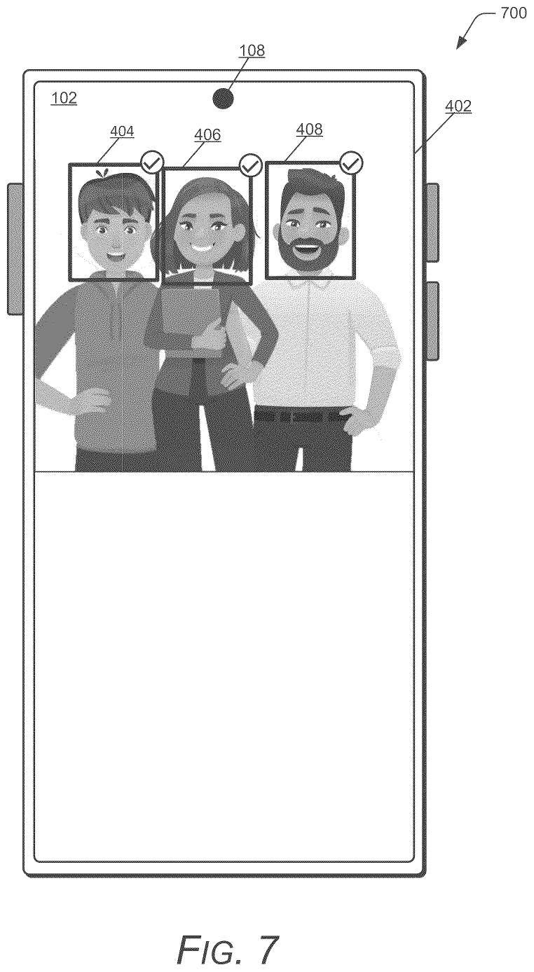

FIG. 7 illustrates an example 700 of generating indications of a face looking away from a camera, including updating the indication of which faces are facing away from the camera in response to detecting that the face that is looking away from the camera has repositioned to looking toward the camera, as described herein. The example 700 is a continuation of the example 400 described with respect to FIG. 4, the example 500 described with respect to FIG. 5, or the example 600 described with respect to FIG. 6.

In the example 700 the gaze manager 122 determines that all of the faces depicted in the preview image 402 are facing the camera 108. For example, after the indication module 128 produces an output involving instructions for faces looking away from the camera 108, the correlation module 126 may determine that all of the faces depicted in the preview image 402 are facing the camera 108.

As illustrated in this example, after the indication module 128 produces an output involving instructions for faces looking away from the camera 108, the first face 302 changes its gaze to look toward the camera 108. Now, the first face 302, the second face 304, and the third face 306 are all facing the camera 108. To convey this, the indication module 128 updates the first indication 404 to a green solid line around the first face 302 to indicate that the first face 302 is now looking toward the camera 108. For example, this may also serve to instruct the people corresponding to the faces to remain looking toward the camera 108 while a digital image is captured. In some example implementations, this may involve the gaze manager 122 causing capture of an updated preview image.

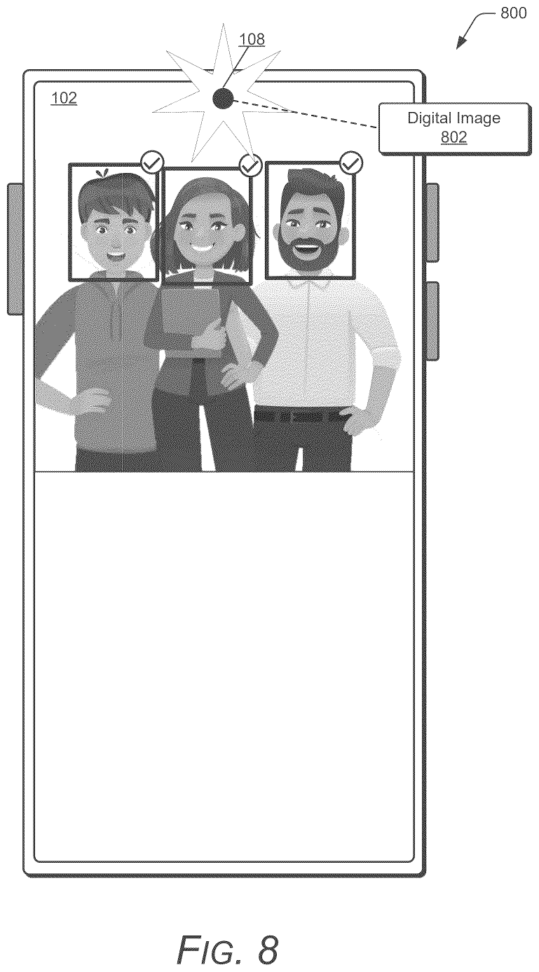

FIG. 8 illustrates an example 800 of generating indications of a face looking away from a camera, including automatically capturing a digital image in response to determining that the faces are looking toward the camera, as described herein. The example 800 is a continuation of the example 700 described with respect to FIG. 7.

In the example 800, the gaze manager 122 captures a digital image 802 in response to determining that all the faces are toward the camera 108. For example, the correlation module 126 may determine that all of the faces depicted in the preview image 402 are facing the camera 108. In response, the gaze manager 122 automatically causes the camera 108 to capture the digital image 802. The digital image 802, for instance, depicts the first face 302, the second face 304, and the third face 306, which are all facing toward the camera. Additionally, the digital image 802 in this example does not include the first indication 404, the second indication 406, or the third indication 408 that are present in the preview image 402. This results in a digital image 802 that features all faces looking toward the camera 108.

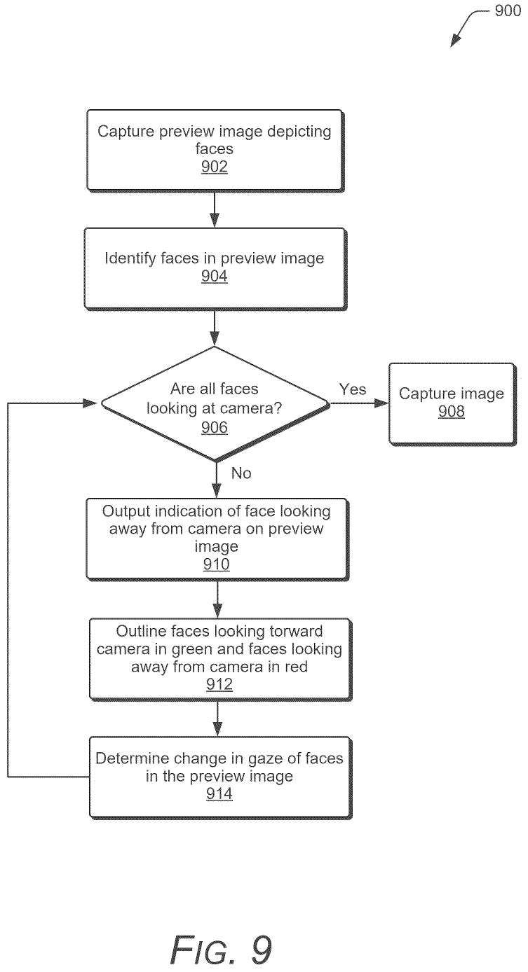

FIG. 9 is a flowchart 900 illustrating an example of generating indications of a face looking away from a camera in accordance with one or more implementations, as described herein.

At 902, a gaze manager 122 causes a preview image 402 depicting faces to be captured by a camera 108 associated with a mobile device 102. As part of this, the gaze manager 122 may display the preview image 402 on a display device visible to a group of people corresponding to the faces. For instance, the preview image 402 may be displayed on a rear-facing display device facing the group of people. Additionally, the gaze manager 122 may cause the preview image 402 depicting the faces to be captured in response to receiving a user input instructing the mobile device 102 to capture a digital image.

At 904, the gaze manager 122 identifies faces in the preview image 402. To do this, the gaze manager 122 may leverage a machine learning model trained on face detection. For instance, the machine learning model may identify faces based on individual facial characteristics and then may isolate the faces from the rest of the preview image 402 for further processing.

At 906, the gaze manager 122 determines whether all of the faces are looking toward the camera 108. If the gaze manager 122 determines that all of the faces are looking toward the camera 108, the gaze manager 122 causes a digital image 802 to be captured, at 908. If the gaze manager 122 determines that at least one of the faces is looking away from the camera 108, the gaze manager 122 causes output of an indication of the face looking away from the camera 108, at 910. For example, the indication of the face looking away from the camera is presented in relation to the preview image 402. At 912, the gaze manager 122 updates the indication of the face looking away from the camera 108 to outline the faces looking toward the camera 108.

At 914, the gaze manager 122 determines whether a change in gaze of the faces in the preview image 402 changes. If the gaze manager 122 determines that all of the faces are looking toward the camera 108, the gaze manager 122 causes a digital image 802 to be captured, at 908. If the gaze manager 122 determines that at least one of the faces is looking away from the camera 108, the gaze manager 122 causes output of an indication of the face looking away from the camera 108.

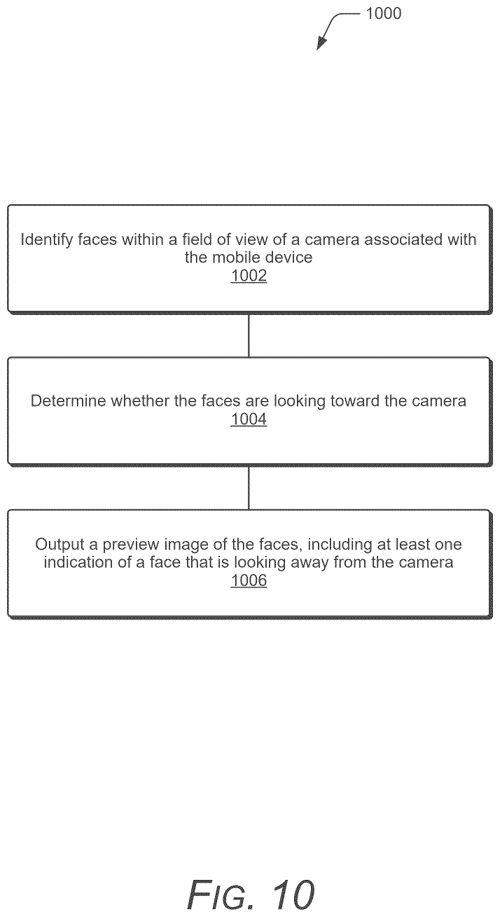

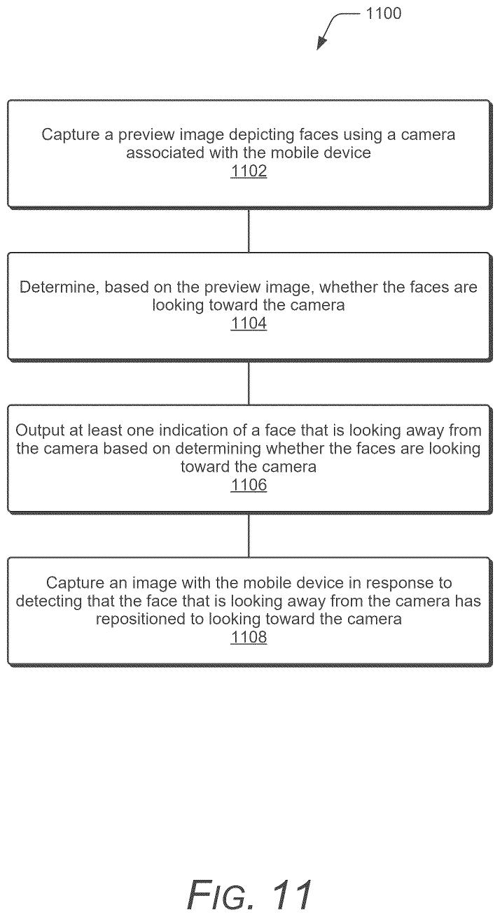

Example methods 1000 and 1100 are described with reference to respective FIGS. 10, and 11 in accordance with one or more implementations of generating indications of a face looking away from a camera, as described herein. Generally, any services, components, modules, managers, controllers, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 10 illustrates example method(s) 1000 for generating indications of a face looking away from a camera. The order in which the method is described is not intended to be construed as a limitation, and any number or combination of the described method operations may be performed in any order to perform a method, or an alternate method.

At 1002, faces are identified faces within a field of view of a camera 108 associated with the mobile device 102. For example, a gaze manager 122 identifies faces within a field of view of a camera 108 associated with the mobile device 102. In some example implementations, the gaze manager 122 may leverage a machine learning model trained on facial detection to identify faces with the field of view.

At 1004, whether the faces are looking toward the camera 108 is determined. For example, the gaze manager 122 determines whether the faces are looking toward the camera 108. In some examples, for instance, the gaze manager 122 may use a known location of the camera 108 to calculate a direction of a gaze for a given face in the field of view to determine which direction the face is looking.

At 1006, a preview image of the faces is output, including at least one indication of a face that is looking away from the camera. For example, the gaze manager 122 outputs a preview image of the faces, including at least one indication of a face that is looking away from the camera. In some example implementations, the gaze manager 122 may automatically capture a digital image after determining that the faces are looking toward the camera 108. For example, the preview image 402 may be displayed on a display device 110 of the mobile device 102 that is viewable from a point of view of the faces. In some example implementations, the preview image 402 of the faces may be a mirrored version of a live image captured by the camera 108. In some example implementations, a graphic may be displayed on the display device 110 of the mobile device 102 and configured to direct the faces to look toward the camera 108. For example, the at least one indication of the face that is looking away from the camera 108 may be outlined in a first color, such as red on the preview image 402, and at least one indication of a different face that is looking toward the camera 108 may be outlined in a second color, such as green on the preview image 402. In some example implementations, the gaze manager 122 may output an audible alert or a visual alert instructing a user corresponding to the face that is looking away from the camera 108. For instance, the visual alert may include an arrow displayed on a display device 110 of the mobile device 102. In some example implementations, the gaze manager 122 may output a flash using a light source associated with the mobile device to indicate a location of the camera 108.

FIG. 11 illustrates example method(s) 1100 for generating indications of a face looking away from a camera. The order in which the method is described is not intended to be construed as a limitation, and any number or combination of the described method operations may be performed in any order to perform a method, or an alternate method.

At 1102, a preview image depicting faces is captured using a camera associated with the mobile device. For example, a gaze manager 122 captures a preview image 402 depicting faces using a camera 108 associated with the mobile device 102. For example, the preview image 402 may be displayed on a display device 110 of the mobile device 102 that is viewable from a point of view of the faces. In some example implementations, the preview image 402 of the faces may be a mirrored version of a live image captured by the camera 108.

At 1104, whether the faces are looking toward the camera is determined based on the preview image. For example, the gaze manager 122 determines, based on the preview image 402, whether the faces are looking toward the camera 108.

At 1106, at least one indication of a face that is looking away from the camera is output based on the determining. For example, the gaze manager 122 outputs at least one indication of a face that is looking away from the camera 108 based on determining whether the faces are looking toward the camera 108. In some example implementations, a graphic may be displayed on the display device 110 of the mobile device 102 and configured to direct the faces to look toward the camera 108. For example, the at least one indication of the face that is looking away from the camera 108 may be outlined in a first color, such as red on the preview image 402, and at least one indication of a different face that is looking toward the camera 108 may be outlined in a second color, such as green on the preview image 402. In some example implementations, the gaze manager 122 may output an audible alert or a visual alert instructing a user corresponding to the face that is looking away from the camera 108. For instance, the visual alert may include an arrow displayed on a display device 110 of the mobile device 102. In some example implementations, the gaze manager 122 may output a flash using a light source associated with the mobile device to indicate a location of the camera 108.

At 1108, a digital image is captured with the mobile device in response to detecting that the face that is looking away from the camera has repositioned to looking toward the camera. For example, the gaze manager 122 captures a digital image with the mobile device 102 in response to detecting that the face that is looking away from the camera 108 has repositioned to looking toward the camera 108.

FIG. 12 illustrates various components of an example device 1200, which can implement aspects of the techniques and features for generating indications of a face looking away from a camera, as described herein. The example device 1200 may be implemented as any of the devices described with reference to the previous FIG. 1-11, such as any type of a wireless device, mobile device, mobile phone, flip phone, client device, companion device, display device, tablet, computing, communication, entertainment, gaming, media playback, and/or any other type of computing, consumer, and/or electronic device. For example, the microphone described with reference to FIGS. 1-11 may be implemented as the example device 1200.

The example device 1200 can include various, different communication devices 1202 that enable wired and/or wireless communication of device data 1204 with other devices. The device data 1204 can include any of the various devices data and content that is generated, processed, determined, received, stored, and/or communicated from one computing device to another. Generally, the device data 1204 can include any form of audio, video, image, graphics, and/or electronic data that is generated by applications executing on a device. The communication devices 1202 can also include transceivers for cellular phone communication and/or for any type of network data communication.

The example device 1200 can also include various, different types of data input/output (I/O) interfaces 1206, such as data network interfaces that provide connection and/or communication links between the devices, data networks, and other devices. The data I/O interfaces 1206 may be used to couple the device to any type of components, peripherals, and/or accessory devices, such as a computer input device that may be integrated with the example device 1200. The I/O interfaces 1206 may also include data input ports via which any type of data, information, media content, communications, messages, and/or inputs may be received, such as user inputs to the device, as well as any type of audio, video, image, graphics, and/or electronic data received from any content and/or data source.

The example device 1200 includes a processor system 1208 of one or more processors (e.g., any of microprocessors, controllers, and the like) and/or a processor and memory system implemented as a system-on-chip (SoC) that processes computer-executable instructions. The processor system 1208 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the device may be implemented with any one or combination of software, hardware, firmware, or fixed logic circuitry that may be implemented in connection with processing and control circuits, which are generally identified at 1210. The example device 1200 may also include any type of a system bus or other data and command transfer system that couples the various components within the device. A system bus can include any one or combination of different bus structures and architectures, as well as control and data lines.

The example device 1200 also includes memory and/or memory devices 1212 (e.g., computer-readable storage memory) that enable data storage, such as data storage devices implemented in hardware which may be accessed by a computing device, and that provide persistent storage of data and executable instructions (e.g., software applications, programs, functions, and the like). Examples of the memory devices 1212 include volatile memory and non-volatile memory, fixed and removable media devices, and any suitable memory device or electronic data storage that maintains data for computing device access. The memory devices 1212 can include various implementations of random-access memory (RAM), read-only memory (ROM), flash memory, and other types of storage media in various memory device configurations. The example device 1200 may also include a mass storage media device.

The memory devices 1212 (e.g., as computer-readable storage memory) provide data storage mechanisms, such as to store the device data 1204, other types of information and/or electronic data, and various device applications 1214 (e.g., software applications and/or modules). For example, an operating system 1216 may be maintained as software instructions with a memory device 1212 and executed by the processor system 1208 as a software application. The device applications 1214 may also include a device manager, such as any form of a control application, software application, signal-processing and control module, code that is specific to a particular device, a hardware abstraction layer for a particular device, and so on.

In this example, the device 1200 includes a gaze manager 1218 that implements various aspects of the described features and techniques described herein. The gaze manager 1218 may be implemented with hardware components and/or in software as one of the device applications 1214, such as when the example device 1200 is implemented as the microphone described with reference to FIGS. 1-11. An example of the gaze manager 1218 is the Communication network 104 implemented by the microphone, such as a software application and/or as hardware components in the mobile device. In implementations, the gaze manager 1218 may include independent processing, memory, and logic components as a computing and/or electronic device integrated with the example device 1200.

The example device 1200 can also include a microphone 1220 (e.g., to capture an audio recording) and/or camera devices 1222, as well as device sensors 1224, such as may be implemented as components of an inertial measurement unit (IMU). The device sensors 1224 may be implemented with various sensors, such as a gyroscope, an accelerometer, and/or other types of motion sensors to sense motion of the device. The device sensors 1224 can generate sensor data vectors having three-dimensional parameters (e.g., rotational vectors in x, y, and z-axis coordinates) indicating location, position, acceleration, rotational speed, and/or orientation of the device. The example device 1200 can also include one or more power sources 1226, such as when the device is implemented as a wireless device and/or a mobile device. The power sources may include a charging and/or power system, and may be implemented as a flexible strip battery, a rechargeable battery, a charged super-capacitor, and/or any other type of active or passive power source.

The example device 1200 can also include an audio and/or video processing system 1228 that generates audio data for an audio system 1230 and/or generates display data for a display system 1232. The audio system and/or the display system may include any types of devices or modules that generate, process, display, and/or otherwise render audio, video, display, and/or image data. Display data and audio signals may be communicated to an audio component and/or to a display component via any type of audio and/or video connection or data link. In implementations, the audio system and/or the display system are integrated components of the example device 1200. Alternatively, the audio system and/or the display system are external, peripheral components to the example device.

Although implementations for generating indications of a face looking away from a camera have been described in language specific to features and/or methods, the appended claims are not necessarily limited to the specific features or methods described. Rather, the specific features and methods are disclosed as example implementations for generating indications of a face looking away from a camera, and other equivalent features and methods are intended to be within the scope of the appended claims. Further, various different examples are described, and it is to be appreciated that each described example may be implemented independently or in connection with one or more other described examples. Additional aspects of the techniques, features, and/or methods discussed herein relate to one or more of the following:

In some aspects, the techniques described herein relate to a mobile device, including at least one memory, and at least one processor coupled with the at least one memory and configured to cause the mobile device to identify faces within a field of view of a camera associated with the mobile device, determine whether the faces are looking toward the camera, and output a preview image of the faces captured by the camera for display on a display device of the mobile device that is viewable from a point of view of the faces, the preview image of the faces including at least one indication of a face that is looking away from the camera.

In some aspects, the techniques described herein relate to a mobile device, wherein the preview image includes a graphic configured to direct the faces to look toward the camera.

In some aspects, the techniques described herein relate to a mobile device, wherein the at least one processor is further configured to automatically capture a digital image in response to determining that the faces are looking toward the camera.

In some aspects, the techniques described herein relate to a mobile device, wherein the at least one indication of the face that is looking away from the camera is outlined in a first color on the preview image, and at least one indication of a different face that is looking toward the camera is outlined in a second color on the preview image.

In some aspects, the techniques described herein relate to a mobile device, wherein the at least one processor is further configured to output an audible alert or a visual alert instructing a user corresponding to the face that is looking away from the camera to look toward the camera.

In some aspects, the techniques described herein relate to a mobile device, wherein the visual alert includes an arrow displayed on the display device of the mobile device.

In some aspects, the techniques described herein relate to a mobile device, wherein the preview image of the faces is a mirrored version of a live image captured by the camera.

In some aspects, the techniques described herein relate to a mobile device, wherein the at least one processor is further configured to output a flash using a light source associated with the mobile device to indicate a location of the camera.

In some aspects, the techniques described herein relate to a mobile device, wherein the at least one processor is further configured to use a machine learning model trained to track eye gaze to determine whether the faces are looking toward the camera.

In some aspects, the techniques described herein relate to a method performed by a mobile device, the method including capturing a preview image depicting faces using a camera associated with the mobile device, determining, based on the preview image, whether the faces are looking toward the camera, outputting at least one indication of a face that is looking away from the camera based on the determining, and capturing a digital image the camera in response to detecting that the face that is looking away from the camera has repositioned to looking toward the camera.

In some aspects, the techniques described herein relate to a method, wherein the preview image is displayed on a display device of the mobile device that is viewable from a point of view of the faces.

In some aspects, the techniques described herein relate to a method, wherein the preview image includes a graphic configured to direct the faces to look toward the camera.

In some aspects, the techniques described herein relate to a method, wherein the at least one indication of the face that is looking away from the camera is outlined in a first color on the preview image, and at least one indication of a different face that is looking toward the camera is outlined in a second color on the preview image.

In some aspects, the techniques described herein relate to a method, further including outputting an audible alert or a visual alert instructing a user corresponding to the face that is looking away from the camera to look toward the camera.

In some aspects, the techniques described herein relate to a method, wherein the preview image of the faces is a mirrored version of a live image captured by the camera.

In some aspects, the techniques described herein relate to a method, further including outputting a flash using a light source associated with the mobile device to indicate a location of the camera.

In some aspects, the techniques described herein relate to a system, including at least one memory, and a gaze manager implemented in a mobile device and configured to capture a preview image depicting faces using a camera associated with the mobile device, determine, based on the preview image, whether the faces are looking toward the camera, output at least one indication of a face that is looking away from the camera and at least one indication of an additional face that is looking toward the camera on the preview image based on determining whether the faces are looking toward the camera, and update the at least one indication in response to detecting that the face that is looking away from the camera has repositioned to looking toward the camera.

In some aspects, the techniques described herein relate to a system, wherein the preview image is displayed on a display device of the mobile device that is viewable from a point of view of the faces.

In some aspects, the techniques described herein relate to a system, wherein the preview image includes a graphic configured to direct the faces to look toward the camera.

In some aspects, the techniques described herein relate to a system, wherein the gaze manager is further configured to automatically capture a digital image in response to determining that the faces are looking toward the camera.

1. A mobile device, comprising:
at least one memory; and
at least one processor coupled with the at least one memory and configured to cause the mobile device to:
identify faces within a field of view of a camera associated with the mobile device;
determine whether the faces are looking toward the camera; and
output a preview image of the faces captured by the camera for display on a display device of the mobile device that is viewable from a point of view of the faces, the preview image of the faces including at least one indication of a face that is looking away from the camera.

2. The mobile device of claim 1, wherein the preview image includes a graphic configured to direct the faces to look toward the camera.

3. The mobile device of claim 1, wherein the at least one processor is further configured to automatically capture a digital image in response to determining that the faces are looking toward the camera.

4. The mobile device of claim 1, wherein the at least one indication of the face that is looking away from the camera is outlined in a first color on the preview image, and at least one indication of a different face that is looking toward the camera is outlined in a second color on the preview image.

5. The mobile device of claim 1, wherein the at least one processor is further configured to output an audible alert or a visual alert instructing a user corresponding to the face that is looking away from the camera to look toward the camera.

6. The mobile device of claim 5, wherein the visual alert includes an arrow displayed on the display device of the mobile device.

7. The mobile device of claim 1, wherein the preview image of the faces is a mirrored version of a live image captured by the camera.

8. The mobile device of claim 1, wherein the at least one processor is further configured to output a flash using a light source associated with the mobile device to indicate a location of the camera.

9. The mobile device of claim 1, wherein the at least one processor is further configured to use a machine learning model trained to track eye gaze to determine whether the faces are looking toward the camera.

10. A method performed by a mobile device, the method comprising:
capturing a preview image depicting faces using a camera associated with the mobile device;
determining, based on the preview image, whether the faces are looking toward the camera;
outputting at least one indication of a face that is looking away from the camera based on the determining; and
capturing a digital image the camera in response to detecting that the face that is looking away from the camera has repositioned to looking toward the camera.

11. The method of claim 10, wherein the preview image is displayed on a display device of the mobile device that is viewable from a point of view of the faces.

12. The method of claim 10, wherein the preview image includes a graphic configured to direct the faces to look toward the camera.

13. The method of claim 10, wherein the at least one indication of the face that is looking away from the camera is outlined in a first color on the preview image, and at least one indication of a different face that is looking toward the camera is outlined in a second color on the preview image.

14. The method of claim 10, further comprising outputting an audible alert or a visual alert instructing a user corresponding to the face that is looking away from the camera to look toward the camera.

15. The method of claim 10, wherein the preview image of the faces is a mirrored version of a live image captured by the camera.

16. The method of claim 10, further comprising outputting a flash using a light source associated with the mobile device to indicate a location of the camera.

17. A system, comprising:
at least one memory; and
a gaze manager implemented in a mobile device and configured to:
capture a preview image depicting faces using a camera associated with the mobile device;
determine, based on the preview image, whether the faces are looking toward the camera;
output at least one indication of a face that is looking away from the camera and at least one indication of an additional face that is looking toward the camera on the preview image based on determining whether the faces are looking toward the camera; and
update the at least one indication in response to detecting that the face that is looking away from the camera has repositioned to looking toward the camera.

18. The system of claim 17, wherein the preview image is displayed on a display device of the mobile device that is viewable from a point of view of the faces.

19. The system of claim 17, wherein the preview image includes a graphic configured to direct the faces to look toward the camera.

20. The system of claim 17, wherein the gaze manager is further configured to automatically capture a digital image in response to determining that the faces are looking toward the camera.
